(19) United States
(12) Patent Application Publication
(10) Pub. No.: US 2016/0259844 A1
(43) Pub. Date: Sep. 8, 2016

(54) MODEL DIRECTED SAMPLING SYSTEM

(71) Applicant: System & Technology Research, LLC, Woburn, MA (US)

(72) Inventors: Kirill Trapeznikov, Somerville, MA (US); Gary Richard Condon, Woburn, MA (US); Eric Kimball Jones, Belmont, MA (US); Peter Brunson Jones, Lexington, MA (US); Nicholas John Pioch, Woburn, MA (US)

(21) Appl. No.: 15/059,838

(22) Filed: Mar. 3, 2016

Related U.S. Application Data
(60) Provisional application No. 62/127,431, filed on Mar. 3, 2015.

(51) Int. Cl. G06F 17/30

(52) U.S. Cl. CPC G06F 17/30598; G06F 17/30867; G06F 17/30528; G06F 17/30604

(57) ABSTRACT

A model-directed sampling system for automatically delivering a customized feed to a plurality of users from a social media service includes a topic model for mathematically inferring a set of abstract topics from a sample stream of content. Upon receiving a selection of user-relevant topics, a query constructor constructs, and continuously refines, a keyword-based query for each user-selected topic. A filter manager then directly interfaces with the social media service and applies the topic queries to a full, continuous media stream. If necessary, the filter manager distributes each topic query across a bank of filters to yield a plurality of individual output streams that are feed rate compliant. By subsequently merging the output streams together, while removing duplicate and/or non-relevant content, a comprehensive yet focused stream of user-relevant content is provided that complies with query requirements established by the social media service.

### STATEMENT REGARDING FEDERALLY SPONSORED RESEARCH OR DEVELOPMENT

This invention was made with government support under Contract Nos. W911NF-12-C-0043 and D14PC00008 awarded by the Defense Advanced Research Projects Agency (DARPA). The government has certain rights in the invention.

### FIELD OF THE INVENTION

The present invention relates generally to the field of social media analytics and more particularly to the auto-curation of a customized social media feed from a social media source.

### BACKGROUND OF THE INVENTION

Social media are computer-based tools, such as websites and applications, which enable content to be created and shared amongst an audience via the internet. The types of content available through typical social media outlets can vary, but most commonly are either text-based (e.g. status updates and commentary) or image-based (e.g. videos and photographs) in nature.

A microblogging service is one form of social media that has grown considerably in prominence. For instance, the TWITTER social networking service is a well-known microblogging service that enables users to send and read relatively short text-based messages. Currently, microblogging participants include both passive users who mainly follow high volume content generators, such as celebrities and news organizations, and active users who use social media to, inter alia, engage in discussions and rally support for causes.

Due to the growth in popularity of social media, the content posted in well-known microblogging services has been found to provide a certain level of value in various applications. For instance, the rapid expansion of microblogging services is proficiently used in the commercial world to support targeted advertising (i.e. advertising to audiences interested certain content). As another example, microblogging services often foster the development of internet memes, which are transient concepts, topics or events (e.g. a catchphrase or activity) that are shared rapidly amongst an audience via the internet.

Social media analytics relates to the examination of social media content. To effectively evaluate content from social media sources, data analytics are commonly employed to parse high volume media streams and separate, or filter, notable content. Through this filtering process, emerging patterns and novel content can be identified close to inception.

The ability of social media analysts to effectively discover relevant content is rendered difficult due to not only the rapid increase in the number of prominent social media sources but also the commensurate rise in the number of regularly active participants who generate continuous streams of posts across a broad range of topics. As a result, the search for relevant, or focused, content amidst the noise inherent in such a prohibitively large volume of largely irrelevant data has been found to be highly challenging.

The effective analysis of social media content also requires access to a complete data stream. By examining a full stream of social media posts, analysts are afforded a more comprehensive, and ultimately more accurate, evaluation. By contrast, analyzing a limited segment of a social media stream introduces the risk of notable content being omitted from evaluation.

However, social media sources often impose feed volume restrictions which preclude comprehensive, all-inclusive review of content for analytic purposes. In other words, providers limit user access to a relatively small fraction of the full data stream. For instance, the TWITTER social networking service only allows access to a filtered, or reduced, feed that does not exceed a certain percentage of the overall feed (e.g. access to nominally low volume streams under defined subscription terms, such 1% of overall feed at no cost). In this manner, the media source is able to preserve exclusivity of access to and proprietorship of the underlying data.

Although precluded access to the full social media stream, analysts can obtain access to limited streams that have been filtered, or separated, from the full stream based on user-defined search parameters. Accordingly, by effectively filtering non-relevant content from the full data stream, a focused stream that complies with feed volume restrictions can be utilized for analysis. For this reason, it is particularly critical that social media stream filtering be effective in parsing content based on user interest, and that the most relevant data be extracted for analysis.

Traditionally, social media analytics rely upon keyword-based search tools to isolate relevant content that may be useful, inter alia, to detect memes or other emerging trends. Typically, keyword-based filters are applied to the full data stream using application program interface (API) search tools provided by the social media service.

As can be appreciated, conventional API search tools provided by social media services have been found to suffer from a couple notable drawbacks.

As a first drawback, conventional API search tools have been found to be highly restrictive. Most notably, API search tools often utilize basic keyword-based filters that have significant limitations (e.g. the number and length of keywords, types of Boolean search operators, etc.). For instance, the keyword-based query applied using the API provided by the TWITTER social networking service only allows for the disjunction of keyword conjunctions (i.e. either (i) keyword 1 and keyword 2, or (ii) keyword 3 and keyword 4). The use of negative operators, such as not, is not permissible to allow for more effective filtering of data. Additionally, each conjunction (e.g. keyword 1 and keyword 2) cannot exceed 60 characters, and the overall query cannot utilize more than 400 conjunctions. As a result, effective filtering of non-pertinent data is not always obtainable using these types of restricted, keyword-based search tools.

As a second drawback, conventional API search tools are typically subjected to feed volume constraints, as referenced above. In other words, only keyword-based queries that yield a filtered stream that complies with predefined, feed rate constraints is deemed acceptable and, in turn, delivered to the user for analysis. As a consequence, it is particularly critical that search tools deliver only the most relevant data to the analyst. Otherwise, the data stream may exceed feed volume constraints. However, it is difficult to establish effective keyword-based queries because social media analysts are only provided with direct access to limited data streams.

As a consequence of the aforementioned drawbacks, it has been found that traditional means for extracting user-relevant, social media content from full data streams is often not only unfocused (i.e. includes irrelevant content) because of inefficiencies in the keyword-based search filters, but also non-inclusive since feed rate constraints often result in the unintentional filtering of relevant content. Consequently, social media analytics often engage in an examination of an incomplete and/or unfocused set of media content, which is highly undesirable.

### SUMMARY OF THE INVENTION

It is an object of the present invention to provide a new and improved system for delivering a customized social media feed from a social media service to each of a plurality of users.

It is another object of the present invention to provide a system as described above wherein each customized social media feed is comprehensive in scope while remaining compliant with feed rate constraints imposed by the social media service.

It is yet another object of the present invention to provide a system as described above that automatically and optimally filters non-relevant content, as defined by the user, from each customized social media feed.

It is still another object of the present invention to provide a system as described above that is inexpensive to construct and easy to implement.

Accordingly, as one feature of the present invention, there is provided a system for delivering a customized feed from a social media service to a user, the system comprising (a) a topic model for inferentially categorizing a set of topics from a continuous, limited sample stream of content from the social media service, (b) a query constructor for constructing a query for each topic selected by the user as relevant, and (c) a filter manager for interfacing with the social media service and applying each user-selected topic query to a continuous, full stream feed of content from the social media service to yield a focused output stream of user-relevant content.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified schematic representation of a novel data network for delivering a customized social media feed from a social media service to each of a plurality of users, the network being constructed according to the teachings of the present invention;

FIG. 2 is a more detailed schematic representation of the model directed sampling system shown in FIG. 1, the model directed sampling system being shown receiving user topic selections to deliver a focused output stream from a social media service;

FIG. 3 is a simplified schematic representation of selected components of the query constructor and database shown in FIG. 2, the representation being useful in understanding the query construction process using a direct query constructor approach; and

FIG. 4 is a chart that depicts query term variances at defined intervals for an actual query generated by an implementation of the MDS system of FIG. 2.

### DETAILED DESCRIPTION OF THE INVENTION

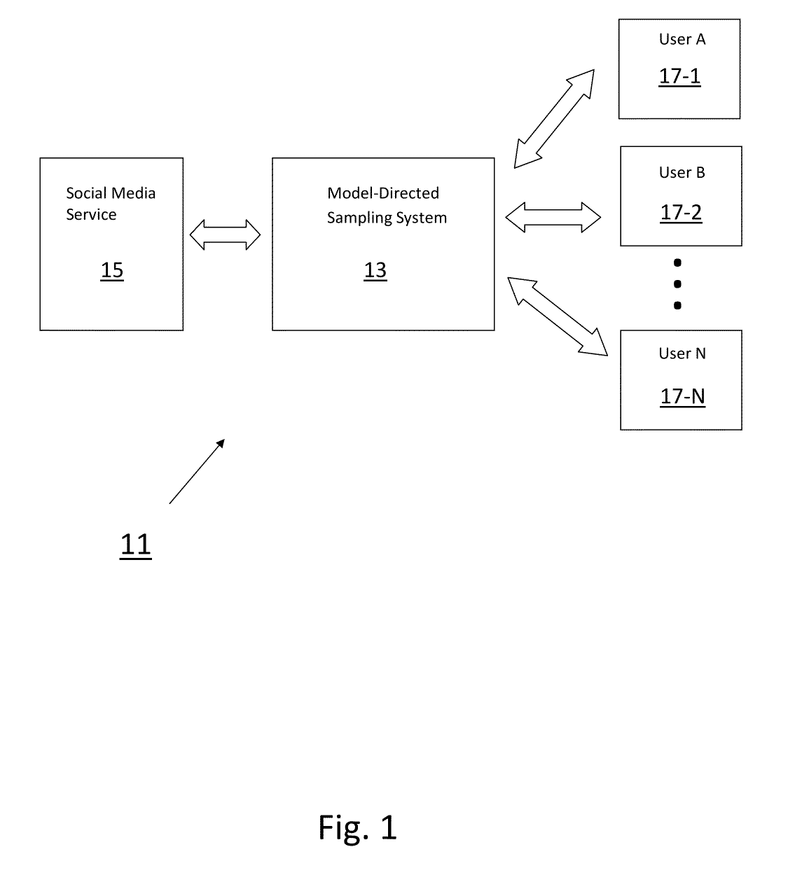

Referring now to FIG. 1, there is shown a novel data network that is constructed according to the teachings of the present invention, the data network being identified generally by reference numeral 11. As can be seen, network 11 comprises a model-directed sampling (MDS) system 13 that receives content from a social media service 15. In turn, MDS system 13 delivers a customized, comprehensive feed of relevant content to each of a plurality of users 17-1 thru 17-n. As a principal feature of the present invention, the customized feed delivered to each user 17 is auto-curated based on user-selected, topic-based preferences and is designed to remain compliant with any feed rate constraints imposed by social media service 15.

For illustrative purposes only, social media service 15 is described herein as a microblogging application, such as the TWITTER social networking service. However, it should be noted that social media service 15 represents any social media source that produces a continuous, high volume, streaming feed of content. Accordingly, it is to be understood that the principles of the present invention could be applied to other types of social media services without departing from the spirit of the present invention.

Additionally, for simplicity purposes, social media service 15 is referenced herein as delivering content from posts or other snippets of text that contain a set of words. However, it should be noted that service 15 is not limited to the delivery of text-based content. Rather, it is to be understood that service 15 could similarly deliver alternative types of content, such as audio-based or video-based content tagged with certain text-based identifiers, without departing from the spirit of the present invention.

Furthermore, in the present example, a single social media service 15 is represented. However, it is conceivable that MDS system 13 could be alternatively configured to deliver a customized feed of content from multiple social media sources without departing from the spirit of the present invention.

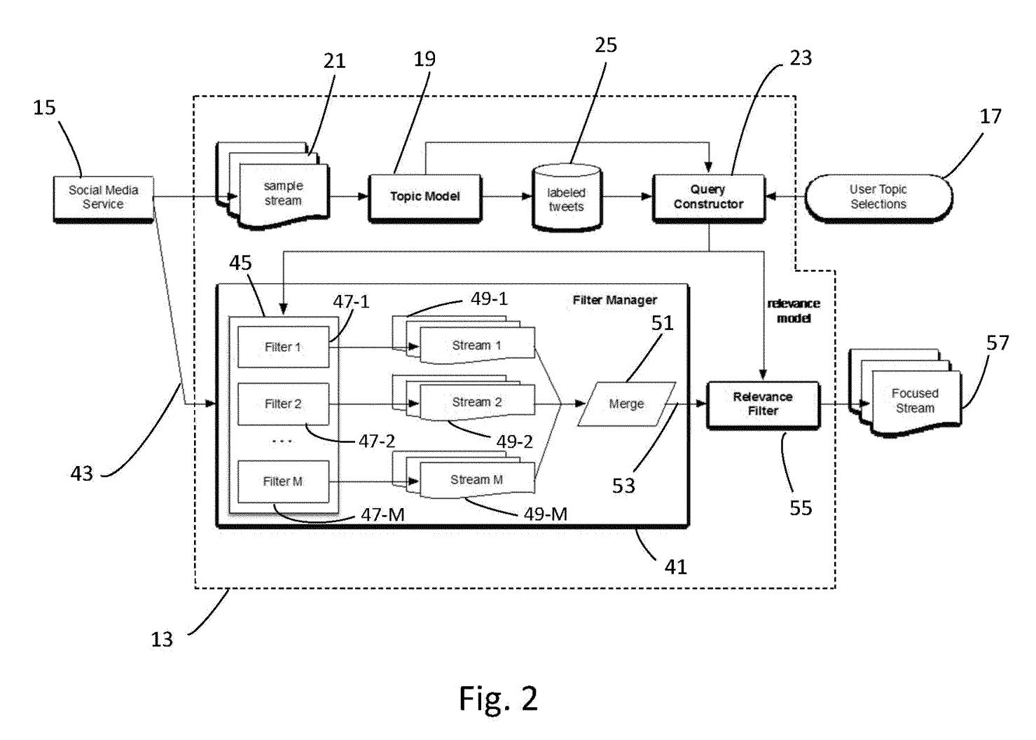

Referring now to FIG. 2, there is shown a more detailed schematic representation of MDS system 13. As will be explained in detail below, MDS system 13 utilizes a two-step approach to apply user-selected, topic-based preferences to a social media feed to produce a focused content stream. In this manner, each user 17 is automatically delivered a custom feed of the most comprehensive, evolving and user-relevant content, while remaining compliant with service feed rate constraints.

As the primary step in the two-step process, MDS system 13 utilizes a reduced-size sample stream of content from social media service 15 to infer a set of abstract topics. Then, by labeling each post in the sample stream with one or more of the defined topics, MDS system 13 is able to construct, and continuously refine, an optimized, keyword-based query for each topic in the set.

Using the set of previously defined topics and associated keyword queries, MDS system 13 then, in the secondary step, applies a user-selected set of topic-based queries to a continuous, full stream of content from social media service 15. As a result, each user 17 is delivered a focused output data stream with user-relevant content that satisfies any/all search constraints established by social media service 15.

To achieve the first step of the aforementioned process, MDS system 13 comprises a topic model 19 for deriving a set of topics from a continuous, limited, sample media stream 21 and a query constructor 23 for designing an optimized, keyword-based query for each topic derived by topic model 19, the details of each to be explained further below.

Topic model 19 engages in a statistical approach to represent a collection of largely unrelated posts with a set of abstract topics. Through such probabilistic modeling, large volumes of unrelated content can be analyzed and inferentially categorized within one or more topic labels. As can be appreciated, the use of an evolving topic-based search approach improves the likelihood that content relevant to a particular topic is delivered to the user relative to a fixed keyword search, even if the content does not include certain principal keyword terms typically associated with the topic. As a result, the filtering process significantly improves the likelihood that all topic-related, but semantically distinct, posts would ultimately be identified and delivered as part of a filtered media stream of relevant content, which is a principal object of the present invention.

In this manner, topic model 19 enables a user 17 to extract and analyze only those posts relating to a particular topic of interest. For instance, an intelligence analyst can extract from a full media stream only those posts that relate to domestic and/or international news. By contrast, a sports analyst may be interested in evaluating only those posts that relate to sports or, more particularly, to a specific sport or team. For most analysts, examination is typically focused on a relatively narrow topic and, as a result, the vast majority of content from the full social media stream is irrelevant and, as such, should be filtered.

Topic model 19 relies upon algorithmic inference to label content. More specifically, topic model 19 uses a stochastic Variational Bayes optimization approach to learn a Latent Dirichlet Allocation (LDA) model of social media topics. In other words, an unsupervised statistical model is learned from a sample stream 21 which enables the high volume of largely unrelated social media posts to be grouped into a set of inferred topics based on the use of common terms.

This enables a topic (e.g. Topic A) to be represented as set of commonly used terms (e.g. Term 1, Term 2, and Term 3), with each term being assigned a unique probability value in connection with the topic (e.g. use of Term 2 represents a 30% probability that the post relates to topic A). In this manner, each topic can be represented by a probability distribution over a predefined word vocabulary (e.g. Topic A—30% probability of Term 2, 10% probability of Term 1, 7% probability of Term 3). As such, a set of topics is established by topic model 19 which enables a future post to be automatically identified, or labeled, as a mixture of one or more of the learned topics based on the presence and topic probability of certain terms within that post.

Accordingly, after inferentially establishing a set of topics, topic model 19 labels each post from sample stream 21 under one or more of the learned topics. The labeled posts are then stored in a corresponding database 25 for future use. As noted above, sample stream 21 is preferably a limited stream that is compliant with any feed rate constraints of social media service 15.

Preferably, the particular number of topics created by topic model 19 can be modified to best suit the needs of the intended application. In other words, if more broad and abstract topics are desired, a limited number of topics is preferably learned by topic model 19. By contrast, if more narrow and focused topics are desired, a larger quantity of topics is preferably learned by topic model 19.

It should also be noted that topic model 19 is preferably designed to continuously update the probability distribution of predefined terms. As a consequence, more effective keyword-based queries can be established by query constructor 23, as will be explained further below.

As seen in FIG. 2, user 17 selects as relevant one or more of the learned topics from a list. For ease of understanding, an illustrative pair of user-selected topics are represented in Table 1 below:

TABLE 1
Topic 35 (0.599) north sony interview korea war obama internet news says
#Iran hack xbox attack christmas psn movie president playstation state
south online squad israelisis release iran salman lizard khan killed
Topic 39 (7.509) 2015 police news years 2014 many black women says
support must missing media read white found men flight children woman
use family social also state high christmas times dead death

As can be seen, topic 35 from the list represents 0.599 percent of the content from sample stream 21. Similarly, topic 39 from the list represents 7.509 percent of the content from sample stream 21. To define each topic, thirty of the highest probability terms associated with the topic are provided rather than a simple identifier (e.g. national news).

Through user selection of relevant topics, a relevance model can be applied (i.e. the probabilistic determination that a post is relevant to the one or more selected topics). To achieve this goal, labeled posts in database 25 are grouped into two separate categories for each topic of interest selected by user 17, namely, (i) a set of posts that are relevant to the user-selected topic and (ii) a set of posts that are irrelevant to the user-selected topic.

As can be appreciated, the two distinct sets of posts can then be used as training sets by query constructor 23, if needed, to design a keyword-based query filter for each user-selected topic. Ideally, the resultant query is able to effectively discriminate between relevant and irrelevant content in future posts.

As will be explained in detail below, each query derived by query constructor 23 is preferably in the form of a disjunction of one or more terms. The query construction process preferably utilizes either a likelihood-based query constructor (LQC) approach or a direct query constructor (DQC) approach, the details of each to be further explained below.

A likelihood-based query constructor (LQC) relies upon word probabilities inferred by topic model 19 (e.g. Topic A—30% probability of Term 2, 10% probability of Term 1, 7% probability of Term 3) to construct an appropriate query (e.g. a disjunction of single terms, such as term A or term B or term C). Because LQC relies entirely upon word probabilities, training sets of posts are not required in this form of relevance modeling, thereby allowing for frequent updating of the resultant query.

Simply stated, LQC utilizes information obtained from topic model 19 to determine a set of T terms that most optimally discriminate between relevant and irrelevant content. To find the most discriminating set of terms for one or more topics (i) user 17 selects one or more relevant topics, (ii) MDS system 13 computes a corresponding relevance model, background model, and likelihood ratio in view of the topic selection, and (iii) MDS system 13 ranks terms according to the likelihood ratio and selects the top, or best, terms to be the query set for the topic(s).

For instance, if user 17 is interested in a specific topic, j, out of an overall set of K topics, the probability, P, that a specific word, w, is relevant, R, can be represented using the following equation:

P(w|R)=P(w|topic j) (1)

Having derived the relevance model for word w in the manner set forth above, a background model for word w can be similarly derived. Specifically, the probability P that word w is irrelevant to topic j and, as such, falls in background, B, can be derived using the following equation.

$$P ( w \vert B ) = P ( w \vert topic \neq j ) = \frac{{\sum }_{k \neq j} P ( w \vert topic k ) P ( topic k )}{{\sum }_{k \neq j} P ( topic k )} \qquad ( 2 )$$

Therefore, for a given post (e.g. a tweet), the optimal classification decision, D, is determined using the threshold of the log-likelihood ratio (wherein V represents the vocabulary in the topic model) as follows:

$$D ( tweet ) = {\sum }_{w ∈ V} {1}_{[ w ∈ tweet ]} log \frac{P ( w \vert R )}{P ( w \vert B )} \geq η \to “ Relevant ” \qquad ( 3 )$$

Because MDS system 13 relies upon the filter API for service 15, the log-likelihood ratio cannot be computed directly. Rather, only the indicator function (i.e. whether a post contains a word or not) can be evaluated. Accordingly, for a set of terms, S, the classification rule, Q, has the following form:

$$Q ( tweet ) = {\sum }_{w ∈ S} {1}_{[ w ∈ tweet ]} \geq 1 \to ” Relevant ” \qquad ( 4 )$$

The objective is thus to determine a set of query terms, S, that best approximates the optimal decision rule. Conceptually, the posts with the highest value for decision, D, in equation (3) are retained. The solution is to establish an optimized query set, S, that includes the top number, T, of the highest ranking words, w, with respect to the log-likelihood ratio:

$$l ( w ) = log \frac{P ( w \vert R )}{P ( w \vert B )} \qquad ( 5 )$$

A direct query constructor (DQC) relies upon a two-phase approach in which one or more terms that frequently occur in labeled training sets of relevant and irrelevant content with respect to the user-selected topics are extracted and, in turn, utilized to adaptively construct an appropriate query.

In the description that follows, each group of one or more terms that frequently occur in the labeled training sets is often referred to simply as an n-gram (i.e. a notable set of N terms contained within a large number of posts). As defined herein, an n-gram encompasses both unigrams (i.e. a single notable term commonly contained within a large number of posts) and bigrams (i.e. a notable pair of terms commonly contained within a large number of posts). Although not described herein, it is envisioned that other increasing conjunctions of word groups could be implemented in the present invention as well (e.g. Term A, and Term B, and . . . Term N). As will be explained further below, each n-gram extracted from the labeled training sets serves as a candidate for query construction (e.g. a possible conjunction of a pair of keyword terms to be used in the constructed query).

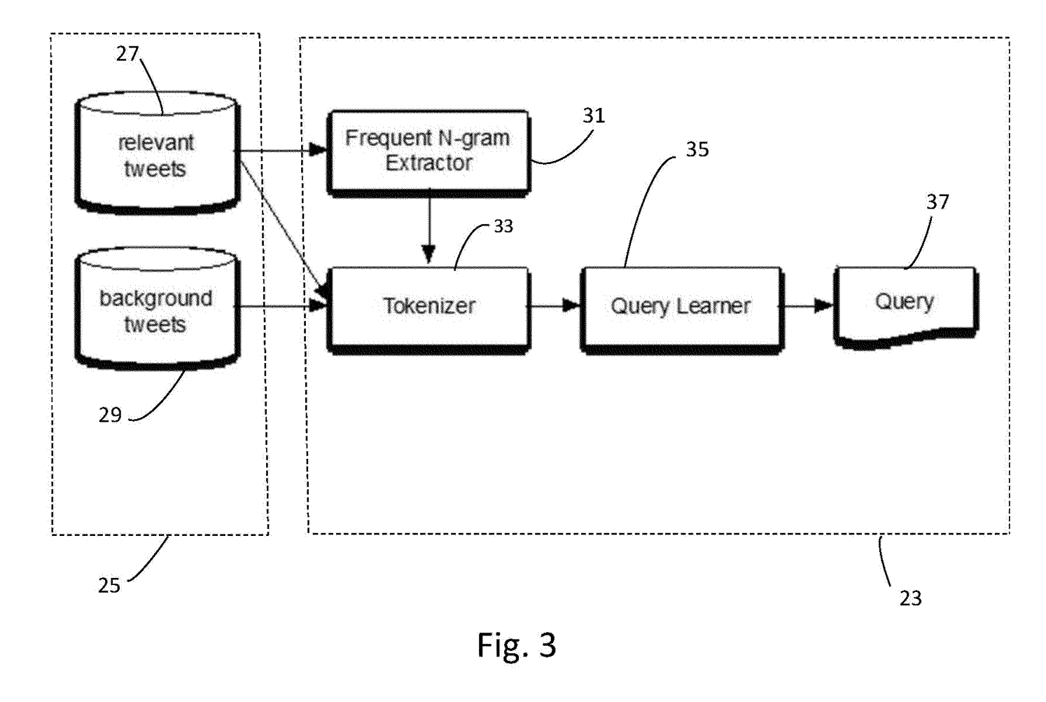

FIG. 3 is a simplified schematic representation of query constructor 23 and database 25 that is useful in understanding the implementation of a query construction process using a DQC approach. As referenced above, query constructor 23 relies upon labeled content from database 25 that is broken into a training set of relevant content 27 and background content 29.

In the first step of the query construction process, an extractor 31 identifies and extracts all n-grams that frequently occur in the training set of relevant content 27. A tokenizer 33 then represents each post from the training set of both relevant content 27 and irrelevant content 29 in terms of n-gram occurrences. In this capacity, tokenizer 33 functions as a bag of tokens that identifies each time an extracted n-gram occurs in the training sets of posts.

In the second step of the query construction process, a query learner 35 initially constructs a query 37 based on the number of n-grams occurrence in tokenizer 33. The particular selection of n-grams utilized in query 37 is refined, over time, to optimize effectiveness. Specifically, each n-gram ultimately incorporated into query 37 preferably provides both (i) maximum coverage across the training set of relevant posts 27 and (ii) minimum overlap with other n-grams of the learned query 37.

For further explanation of the above-referenced process, assume that extractor 31 extracts a set of K n-grams, with j denoting the index of each n-gram. Each post, i, can thus be compactly represented as a K dimensional binary vector xᵢ which encodes an n-gram occurrence in the post i. If the post i contains n-gram j, then xᵢⱼ=1. Otherwise, xᵢⱼ=0.

Also assume that query 37 is limited to the use of a defined number, T, of n-grams. Accordingly, it is the objective of query learner 35 to select a query that includes a subset of the T n-grams that (i) maximizes the number of relevant posts 27 and (ii) minimizes the number of background posts 29.

Thus, resultant query 37 can be represented by a K dimension binary vector s. If an element sⱼ=1, then the jth n-gram is selected as part of the query; otherwise, sⱼ=0. Using this notation, a post, i, matches a query, s, if s^{T}xᵢ≧1. Further, the objective of the problem can be represented in the following form:

$${max}_{s ∈ {\{ 0 , 1 \}}^{K}} {\sum }_{i ∈ R} {1}_{{s}^{T} {x}_{i} \geq 1} - {\sum }_{i ∈ B} {1}_{{s}^{T} {x}_{i} \geq 1} s . t . {\sum }_{j} {s}_{j} \leq T \qquad ( 6 )$$

In equation (6), R corresponds to a set of relevant posts (i.e. tweets 27) and B corresponds to a set of irrelevant posts (i.e. tweets 29). This results in an integer-programming problem that is typically intractable.

Therefore, instead of solving for an optimal query solution, s, query learner 35 performs an approximate greedy optimization process. Specifically, query learner 35 aggregates a set of T n-grams. At each step of the optimization process, an n-gram j with maximum coverage on the training set and minimum overlap with the other query n-grams is added to the query.

At step t of the optimization process, t n-grams will have been added to the query, resulting in a query set, S_{T}. The classification performance of the current query can thus be denoted by a binary vector c^{t}. In turn, if a post, i, matches the query, then cᵢ=1, as represented below:

$${c}_{i}^{t} = \{ \begin{matrix}1 , & {\sum }_{j ∈ {S}_{t}} {x}_{ij} \geq 1 \\ 0 , & else\end{matrix} \qquad ( 7 )$$

The optimization process continues by selecting another n-gram, j, which has (i) maximum coverage and minimum overlap on the relevant set of posts 27 and (ii) minimum coverage and maximum overlap on the irrelevant set of posts 29. Using the greedy objective set forth in equation (6), the following can be represented:

$${max}_{j ∉ {S}^{t}} {\sum }_{i ∈ R} ( {x}_{ij} - {x}_{ij} {c}_{i}^{t} ) - {\sum }_{i ∈ B} ( {x}_{ij} - {x}_{ij} {c}_{i}^{t} ) \qquad ( 8 )$$

In equation (8), the first summation term corresponds to the number of relevant posts that match extracted candidate n-gram, j, and that does not match the current query. The second summation has the opposite meaning with respect to the number of background posts. Accordingly, if n-gram post occurrences are stored as a sparse matrix, the objective evaluation reduces to a simple multiplication problem that can be quickly computed.

Using either the LQC or DQC strategy set forth in detail above, constructor 23 creates a keyword-based filter query for the user-selected topics. Regardless of the method, the query constructed includes a disjunction of conjunctions (i.e. conjunction A or conjunction B or . . . conjunction N), with each conjunction being represented as either a single term (e.g. Term 1) or a pair of terms (Term 1 and Term 2).

Preferably, the specific terms associated with each query is frequently updated to yield an optimal search filter. In particular, as the topic model evolves periodically, the query associated with each topic model is updated in a corresponding fashion. Preferably, each query adapts to the changing content on service 15 by changing in a controlled manner.

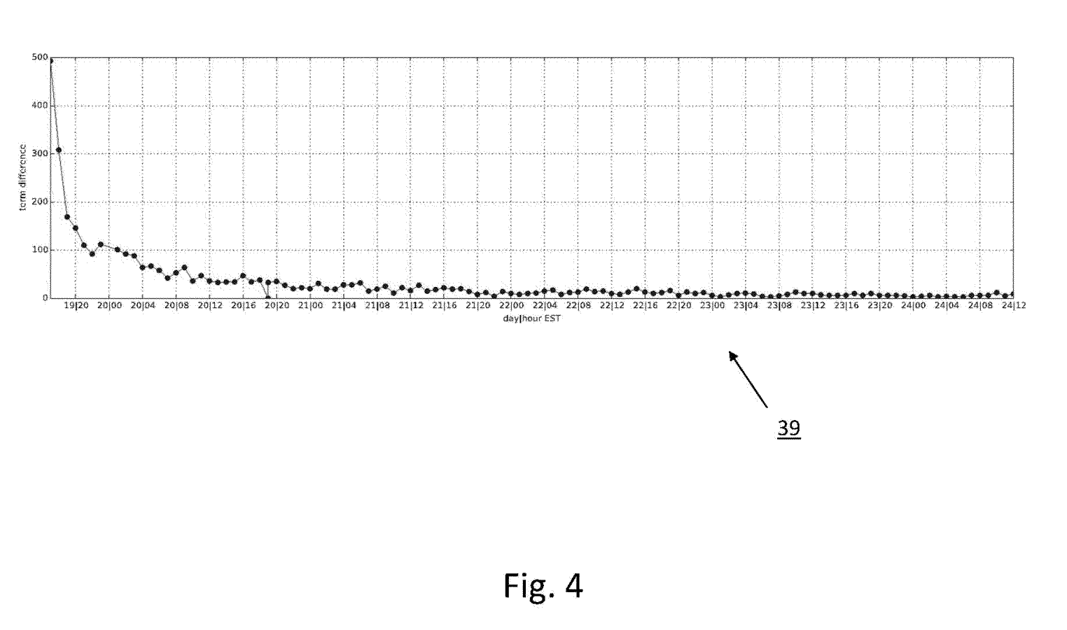

To illustrate this point, FIG. 4 is a chart 39 that depicts the variance in specific query terms at predefined intervals, or updates, for an actual implementation of MDS system 13 used to create a customized, topic-based query that includes a set of 400 query terms. As can be seen, immediately after topic model initialization, the number of term variances is relatively large as the topic model evolves and converges. Then, over time, the number of term variances tends to asymptotically approach zero and is consistently less than 10.

As referenced above, MDS system 13 utilizes a two-step approach to deliver user-curated content from social media service 15 to a plurality of users 17. In the first step, MDS system 13 uses a topic modeling tool (i.e. topic model 19) to mathematically identify a cluster of common terms, which together most accurately represent a particular topic or category, from a limited sample stream of content 21. In turn, a query constructor 23 constructs an appropriate search query for each topic identified by user 17 as relevant.

In the second step, a filter manager 41 directly interfaces with social media service 15 and applies the previously constructed and continuously evolving topic queries to a full, continuous social media stream 43 derived from service 15, as shown in FIG. 2. More specifically, filter manager 41 comprises a filterbank 45 with a plurality of individual filters 47-1 thru 47-M. To effectively filter relevant content from the full media stream 43, filter manager 41 applies the constructed query for each user-selected topic to one or more corresponding filters 47.

Preferably, each topic query not only is effective in extracting the most relevant content from full media stream 43 but also is compliant with any query requirements defined by social media service 15. For instance, each topic query preferably satisfies any query format and/or length requirements of the social media provider API. As will be explained further below, each topic query is also rendered compliant with feed rate volume restrictions through distributed collection, when required.

As referenced above, social media provider APIs are typically subject to predefined feed rate constraints. As a consequence, only queries that yield an output stream in compliance with such a volume restriction will ultimately be provided to user 17. For instance, the TWITTER social networking service requires that a query yield a filtered stream that is no greater than 1% of the total feed.

To ensure compliance with feed rate restrictions, MDS system 13 determines whether each constructed topic query yields an output feed that complies with the allowed feed rate limit. As a feature of the present invention, queries that exceed the allowed rate limit are partitioned into a collection of rate-compliant sub-queries. Through distributed collection, the query can thus be rendered rate compliant.

Specifically, a topic with a non-compliant query is inferentially divided into a plurality of subtopics by topic model 19. It should be noted that the plurality of subtopics is inferentially derived by topic model 19 in the same manner that the initial set of topics are inferentially learned (i.e. through probabilistic modeling). The particular number of subtopics utilized for each topic is selected such that each of the plurality of sub-queries meets feed volume restrictions.

In turn, query constructor 23 constructs a corresponding rate-compliant query for each of the plurality of subtopics. Each subtopic query is preferably constructed by query constructor 23 using either the LQC or DQC procedure set forth in detail above. Because the subtopic modeling process implicitly favors distinct, or non-overlapping, subtopics, the overlap among subtopic queries is minimized.

To accomplish the aforementioned distributed collection of content, filter manager 41 divides a topic query which would otherwise yield an output feed that exceeds predefined feed rate constraints across the plurality of individual query filters 47. The plurality of corresponding reduced-volume output streams 49-1 thru 49-M produced from individual filters 47-1 thru 47-M, respectively, is then merged together by filter manager 41, as represented by reference numeral 51. The output of the data merge is an aggregated, filtered data stream 53 that accounts for the user-selected topic(s). Preferably, any duplicate posts are removed from merged data stream 53 for greater analytic efficiency.

Accordingly, by dividing a non-compliant topic query into a plurality of rate-compliant sub-queries, each of which is applied with a corresponding filter 47, effective filtering of the full feed 43 can be achieved for the user-selected topic. In this capacity, a highly focused stream of relevant content, which would otherwise exceed feed rate volume constraints, can be delivered to user 17 for analytic purposes.

As such, it is to be understood that filter manager 41 is responsible for a number of important tasks. Specifically, filter manager 41 continuously receives updates from query constructor 23 to ensure accuracy of the user-selected topic queries. Additionally, filter manager 41 (i) interfaces with the relevant API for social medial service 15, and (ii) initializes the individual filter streams in order to extract pertinent content from full stream 43. If a distributed collection is utilized, filter manager 41 also merges individual streams 49 and removes any duplicate posts from merged stream 53.

As an optional step, the filter manager output stream 53 is then applied to a relevance filter 55 to ensure that all the content in merged feed 53 is relevant. More specifically, relevance filter 55 removes content from merged stream 53 that does not match the true relevance model for the user-selected topics.

Relevance filter 55 is preferably defined by query constructor 23 using the topics of interest selected by the user. The topics of interest are represented as a distribution over words in a defined vocabulary. By evaluating the words in a post, MDS system 13 can compute the likelihood that the post matches the relevance model using basic hypothesis testing methods, such as a Naïve Bayes probability model.

Upon completion of relevance filtering by filter 55, a focused output stream 57 is delivered to user 17 by MDS system 13 that is highly precise and accurate with respect to the selected topics (i.e. the feed contains the most relevant content). At the same time, output stream 57 is comprehensive in scope, but not hindered by otherwise obtrusive feed rate restrictions.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for delivering a customized feed from a social media service to a user, the system comprising:
(a) a topic model for inferentially categorizing a set of topics from a continuous, limited sample stream of content from the social media service;
(b) a query constructor for constructing a query for each topic selected by the user as relevant; and
(c) a filter manager for interfacing with the social media service and applying each user-selected topic query to a continuous, full stream feed of content from the social media service to yield a focused output stream of user-relevant content.

2. The system as claimed in claim 1 wherein the topic model inferentially categorizes the set of topics through probabilistic modeling.

3. The system as claimed in claim 2 wherein the topic model uses a stochastic Variational Bayes optimization approach to inferentially learn the set of topics.

4. The system as claimed in claim 2 wherein the topic model represents each of the set of topics as a probability distribution of terms.

5. The system as claimed in claim 4 wherein the topic model continuously updates the probability distribution of terms for each of the set of topics.

6. The system as claimed in claim 4 wherein the topic model labels content from the sample stream using at least one of the set of topics.

7. The system as claimed in claim 4 wherein the query constructor utilizes a likelihood-based query constructor (LQC) approach to construct a query for each topic selected by the user as relevant.

8. The system as claimed in claim 7 wherein the query constructor utilizes the probability distribution of terms represented by the topic model to discriminate between relevant and irrelevant content for each of the set of topics.

9. The system as claimed in claim 6 wherein the query constructor utilizes a direct query constructor (DQC) approach to construct a query for each topic selected by the user as relevant.

10. The system as claimed in claim 9 wherein the query constructor uses the labeled content from the sample stream to extract a set of most prevalent terms for each of the set of topics.

11. The system as claimed in claim 10 wherein the extracted set of most prevalent terms for each topic is utilized by the query constructor to construct a corresponding query.

12. The system as claimed in claim 1 wherein the filter manager applies each query derived from the query constructor to a corresponding filter.

13. The system as claimed in claim 2 wherein the filter manager comprises a filterbank with a plurality of individual filters.

14. The system as claimed in claim 13 wherein the filter manager applies a rate-compliant query derived from the query constructor to a corresponding filter in the filterbank.

15. The system as claimed in claim 14 wherein the filter manager distributes each query that is non-compliant with feed rate restrictions into a plurality of sub-queries that are compliant with feed rate restrictions.

16. The system as claimed in claim 15 wherein each of the plurality of sub-queries is applied to a corresponding filter in the filterbank.

17. The system as claimed in claim 16 wherein the representative topic for each query that is non-compliant with feed rate restrictions is inferentially divided into a plurality of subtopics by the topic model.

18. The system as claimed in claim 17 wherein the query constructor constructs the plurality of rate-compliant sub-queries.

19. The system as claimed in claim 18 wherein the filter manager merges content produced from the plurality of individual filters in the filterbank to yield a merged output stream.

20. The system as claimed in claim 19 wherein the filter manager removes duplicative content from the merged output stream to yield the focused output stream of user-relevant content.
